(19) United States
(12) Patent Application Publication
(10) Pub. No.: US 2009/0041631 A1
(43) Pub. Date: Feb. 12, 2009

(54) Ejection device for biosensor detector

(75) Inventor: Ching-Hsin CHO, Taipei Hsien (TW)

Correspondence Address: POSZ LAW GROUP, PLC, 12040 SOUTH LAKES DRIVE, SUITE 101, RESTON, VA, 20191, US

(73) Assignee: BIOMEDIX TAIWAN CO., LTD., Taipei Hsien (TW)

(21) Appl. No.: 11/905,764

(22) Filed: Oct. 4, 2007

(30) Foreign Application Priority Data
Aug. 8, 2007 (TW) 09613029

(51) Int. Cl. B01L 9/00

(52) U.S. Cl. 422/104

(57) ABSTRACT

An ejection device for a biosensor detector has a body that has a front end, an insertion slot formed in the front end, an ejection mount and a resilient element. The ejection mount has a recess with a guide protrusion being mounted near the front end of the body, two button guides being formed in the ejection mount, an ejection button being mounted on the body and adjacent to the insertion slot, two guide tabs and a limit mounted in the recess. The guide tabs are mounted slidably in the button guides to slidably hold the ejection button on the body. The resilient element is mounted in the recess and has a proximal end being mounted on the guide protrusion and a distal end to move the ejection button forward. Therefore, a patient or carer can eject the biosensor conveniently and safely.

### BACKGROUND OF THE INVENTION

1. Field of Invention

The present invention relates to an ejection device, and more particularly to an ejection device for a biosensor detector, wherein the transducer ejects a biosensor conveniently and hygienically from the biosensor detector.

2. Description of the Related Art

Patients who suffer from diabetes or other such illness routinely go to hospital for periodic blood tests. Advancements in biotechnology have led to a home testing system that includes a biosensor and a biosensor detector which are used to allow patients to check their physical condition virtually anywhere.

The biosensor has a reactive element. The reactive element comprises an enzyme that reacts with a drop blood or other liquid sample to generate an electric current. Therefore, the patient must pierce their finger to remove the drop of blood or other liquid sample and transfer blood or other liquid sample onto the reactive element of the biosensor. The biosensor is then mounted in the biosensor detector. The blood reacts with the reactive element to generate electric current that is picked up by the biosensor detector to display a test result on a screen of the biosensor detector. The biosensor only needs a little blood or other liquid sample and is very quick and convenient for patients and carers to determine patient's physical condition.

A conventional biosensor detector has an inner circuit and an insertion hole. After the biosensor is inserted into the insertion hole, the biosensor makes contact with the inner circuit of the biosensor detector, so the biosensor detector can detect the electric circuit of the biosensor. However, after the biosensor detector detects the biosensor, the biosensor must be removed by hand. Since the patient has an open wound, the biosensor may be contaminated by the patient's blood. Moreover, the carers must wear personal protective equipment to prevent contact with the patient's blood during testing. This lengthens testing time and inconveniences carers.

To overcome the shortcomings, the present invention provides an ejection device for a biosensor detector to mitigate or obviate the aforementioned.

### SUMMARY OF THE INVENTION

The primary objective of the present invention is to provide an ejection device for a biosensor detector, the ejection device ejects a biosensor conveniently and hygienically from the biosensor detector.

To achieve the objective, the ejection device for a biosensor detector in accordance with the present invention has a body. The body has a front end, an insertion slot, an ejection mount and a resilient element. The insertion slot is formed in the front end of the body. The ejection mount has a recess, two button guides, an ejection button, two guide tabs and a limit. The recess has a guide protrusion. The guide protrusion is mounted near the front end of the body. The ejection button guides are formed in the ejection mount. The ejection button is mounted on the body and adjacent to the insertion slot. The guide tabs are mounted slidably in the button guides to slidably hold the ejection button on the body. The limit is mounted in the recess. The resilient element is mounted in the recess and has a proximal end and a distal end. The proximal end is mounted on the guide protrusion. The distal end presses the ejection button forward. Therefore, a patient or carer can eject the biosensor conveniently and safely.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an ejection device for a biosensor detector in accordance with the present invention;

FIG. 2 is an exploded perspective view of the ejection device in FIG. 1;

FIG. 3 is a side view in partial section of the ejection device in FIG. 2 before a biosensor is inserted into an insertion slot;

FIG. 4 is a side view in partial section of the ejection device for a biosensor detector in FIG. 3, showing the biosensor inserted in the insertion slot;

FIG. 5 is an exploded perspective view of a second embodiment of an ejection device for a biosensor detector in accordance with the present invention;

FIG. 6 is a an operational top view of the ejection device in FIG. 5 before a biosensor is inserted into an insertion slot;

FIG. 7 is an operational top view of the ejection device in FIG. 6, showing the biosensor inserted into the insertion slot;

FIG. 8 is a perspective view of an ejection device for a biosensor detector in accordance with the present invention, shown connected to a biosensor detector; and

FIG. 9 is a perspective view of an ejection device for a biosensor detector in accordance with the present invention mounted in a biosensor detector.

### DETAILED DESCRIPTION OF THE INVENTION

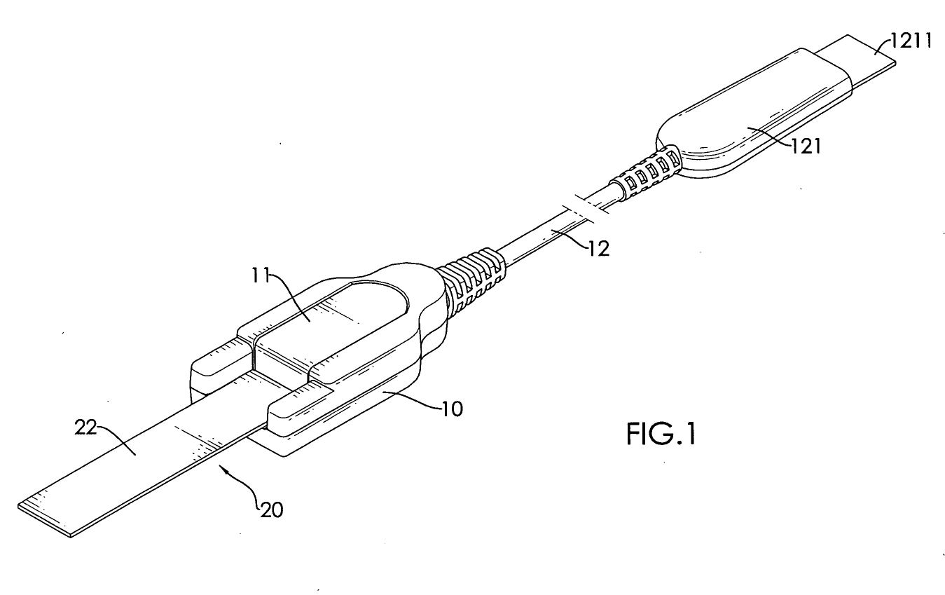

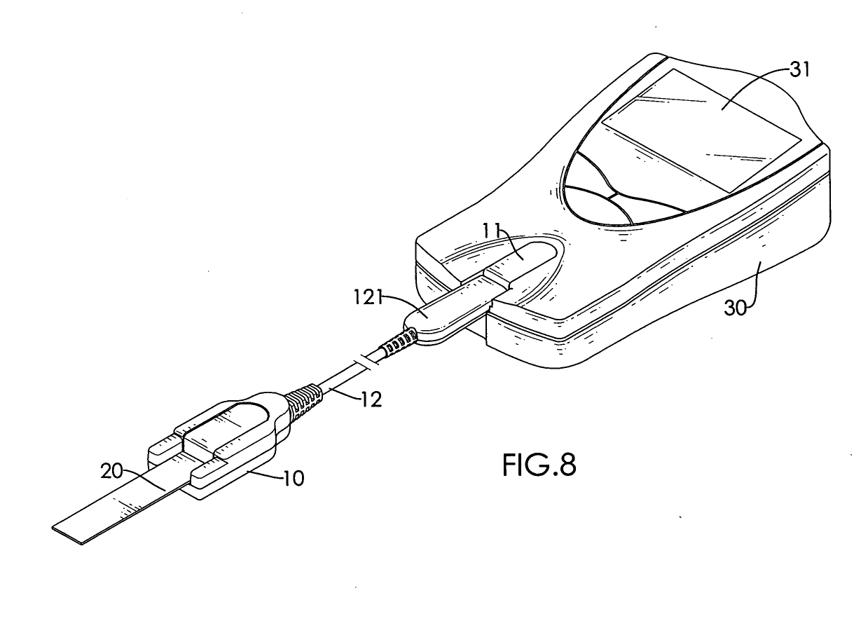

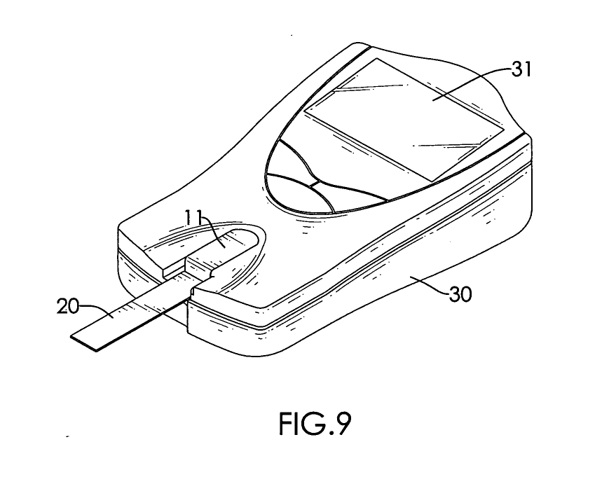

With reference to FIGS. 1, 8 and 9, a biosensor detector (30) is implemented with a disposable biosensor (20), comprises a screen (31) and an ejection device in accordance with the present invention.

The ejection device is connected electrically to the sensor (30) and receives and detects a biosensor (20).

The biosensor (20) is a sensor strip. The sensor strip is folded and comprises a base (21) with electrodes and a cover (22) that is shorter than the base (21) of the biosensor (20).

The screen (31) displays test values.

The ejection device is connected electrically to the detector (30), may be mounted in the biosensor detector (30) and has a body (10).

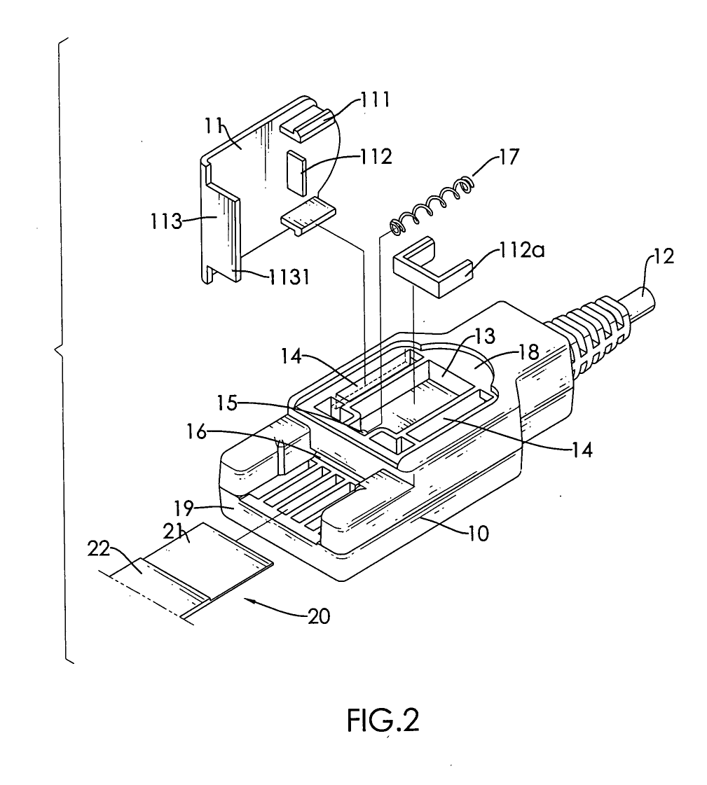

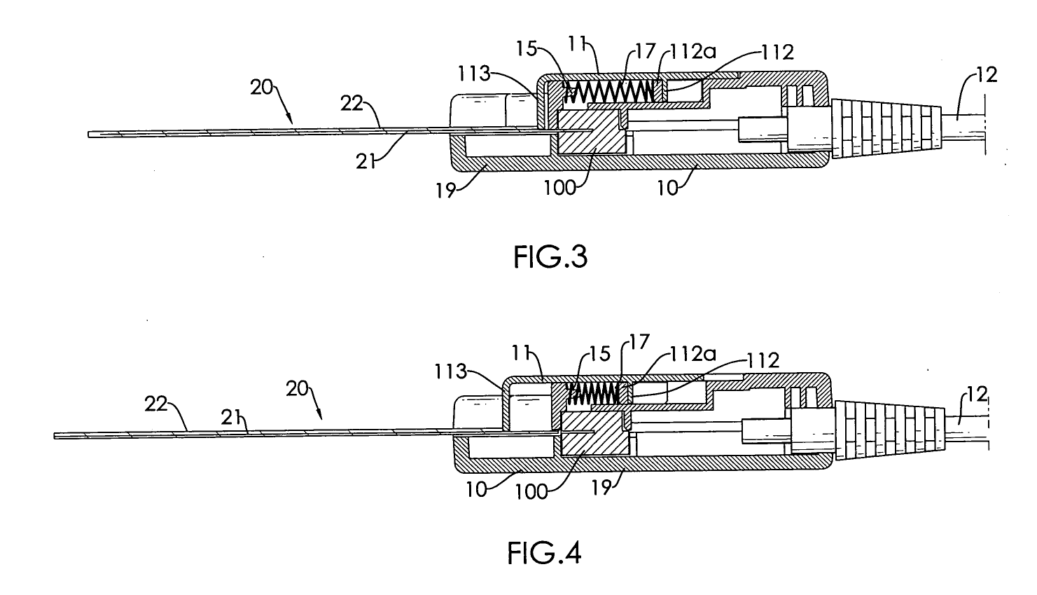

With further reference to FIGS. 2 and 3, the body (10) has an upper surface, an inner chamber, a front end, a rear end, a detecting circuit (100), an insertion slot (16), an ejection mount (18), an ejection button (11), a resilient element (17, 17′), a guiding platform (19) and a electrical wire (12).

The inner chamber is formed in the body (10) and near the front end.

The detecting circuit (100) is mounted in the inner chamber.

The insertion slot (16) is defined through the front end of the body (10), corresponds to and allows the base (21) of the biosensor (20), to be inserted through, make contact with and be detected by the detecting circuit (100).

With further reference to FIG. 5, the ejection mount (18) is formed longitudinally in the upper surface of the body (10), communicates with the front end of the body (10) and has two sides, a recess (13) and a first fastener.

The recess (13) is formed in the ejection mount (18) and has a surface, two sides, a front end, a rear end and a guide protrusion (15, 15′). The front end of the recess (13) corresponds to the front end of the body (10). The rear end of the recess (13) corresponds to the rear end of the body (10). The guide protrusion (15, 15′) is mounted near the front end of the body (10).

In a first embodiment of the present invention the guide protrusion (15) protrudes from the front end of the recess (13).

In a second embodiment of the present invention the guide protrusion (15′) is mounted on the surface of the recess (13) near the front end of the recess (13).

In the second embodiment the recess (18) further comprises a partition (131). The partition (131) is formed on and protrudes asymmetrically from the rear end of the recess (13) to form an interval (132) between the partition (131) and the side of the recess (13).

The first fastener comprises two button guides (14, 14′). The button guides (14, 14′) are formed in the ejection mount (18) and each button guide (14, 14′) is L-shaped in cross-section.

In the first embodiment, the button guides (14) are formed respectively in the sides of the ejection mount (18).

In the second embodiment, the button guides (14′) are formed respectively in the sides of the recess (13).

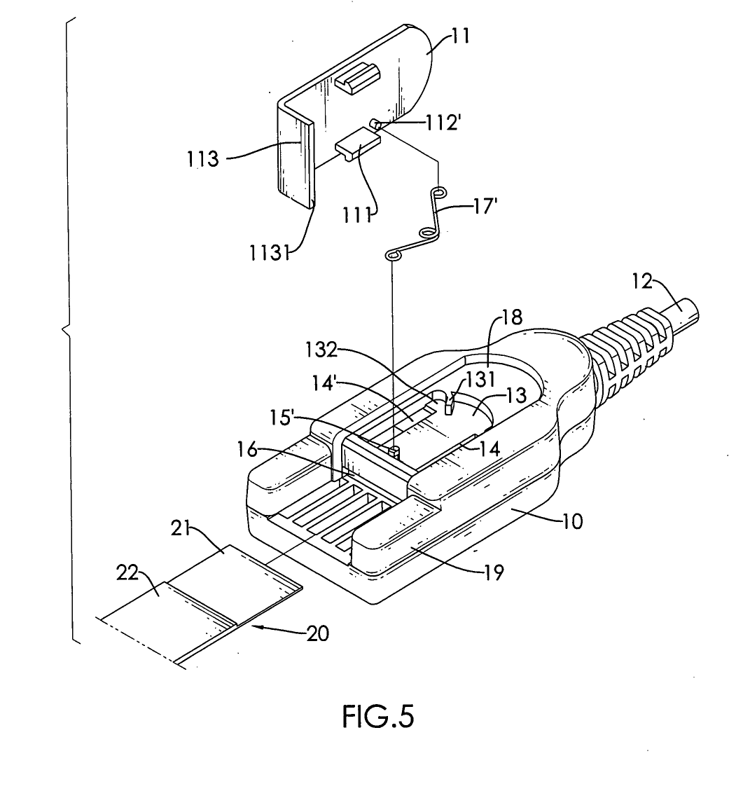

With further reference to FIG. 4, the ejection button (11) is mounted slidably in the ejection mount (18) and has a proximal end, a lower surface, an ejection tab (113), a second fastener and a limit.

The ejection tab (113) is formed perpendicularly from the proximal end of the ejection button (11) and has a bottom edge (1131). The bottom edge (1131) is level with and adjacent to the insertion slot (16) and abuts the cover (22) of the biosensor (20) when the base (21) of the biosensor (20) is inserted into the insertion slot (16). Therefore, when the ejection button (11) is pushed forward, the biosensor (20) is reliably and controllably slid out of the ejection device.

The second fastener protrudes from the lower surface of the ejection button (11), correspond respectively to the first fastener of the ejection mount (18) to fasten the ejection button (11) to the body (10). The second fastener comprises two guide tabs (111). The guide tabs (111) protrude from the lower surface of the ejection button (11), correspond respectively to and are slidably mounted respectively in the button guides (14, 14′) to slidably hold the ejection button (11) on the body (10) and control motion of the guide tabs (111) along the button guides (14, 14′) to maintain reliable motion.

The limit comprises a protruding tab (112, 112′) formed on and protruding from the lower surface of the ejection button (11), being mounted in the recess (13) and keeping a distance from the guide protrusion (15, 15′).

In the first embodiment, the limit further comprises a sliding stopper (112a). The protruding tab (112) is further mounted between the guide tabs (111). The sliding stopper (112a) is mounted between the protruding tab (112) and the guide protrusion (15), abuts the protruding tab (112) and the sides of the recess (13), is U-shaped and has two ends that abutting the rear end of the recess (13).

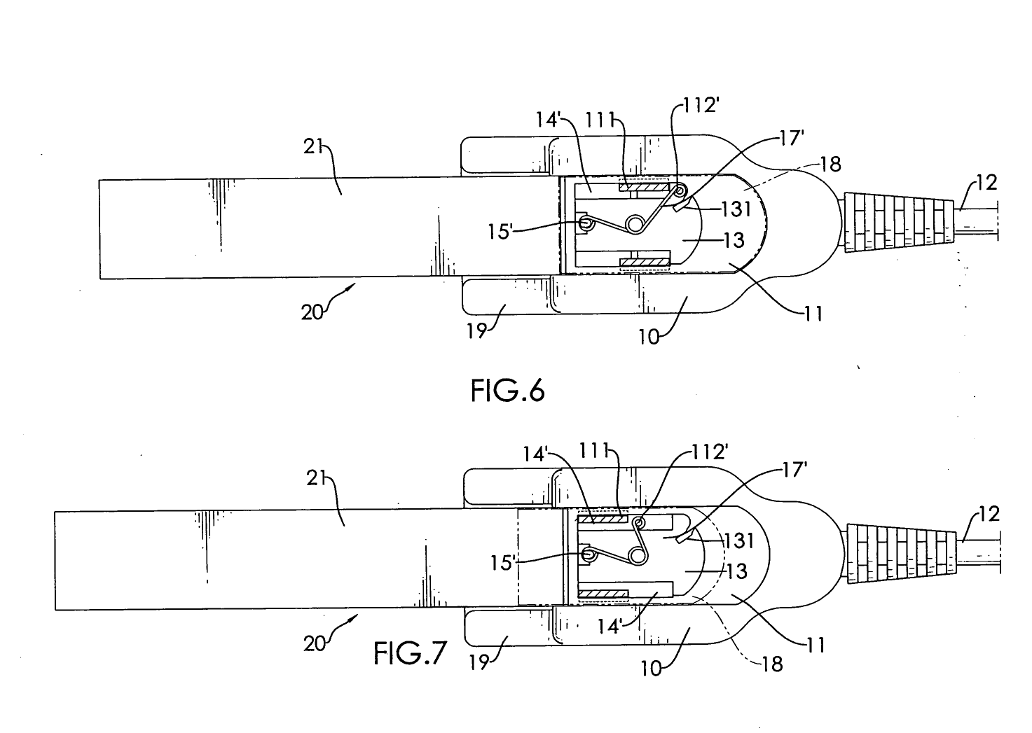

With further reference to FIG. 6, in the second embodiment, the protruding tab (112′) is a cylinder and further corresponds to and is mounted in the interval (132).

With further reference to FIG. 7, the resilient element (17, 17′) is mounted in the recess (13) and has a proximal end and a distal end. The proximal end is mounted on the guide protrusion (15, 15′). The distal end is connected to the limit and presses the ejection button (11) away from the front end of the body. Therefore, after the ejection button (11) is pushed forwards to eject the biosensor (20), the resilient element (17, 17′) presses and returns the ejection button (11) back to the rear of the body (10) so another biosensor (20) may be inserted.

In the first embodiment, the resilient element (17) is a spiral compression spring. The proximal end of the resilient element (17) is mounted on the guide protrusion (15). The distal end abuts and presses the sliding stopper (112a) against the rear end of the recess (13). In the second embodiment, the resilient element (17′) of the present invention is a helical torsion spring. The proximal end of the resilient element (17′) is mounted on the guide protrusion (15′). The distal end is mounted on the protruding tab (112′).

The guiding platform (19) is U-shaped and protrudes from the front end of the body (10), corresponds to the insertion slot (16) and guides the biosensor (20) into the insertion slot (16).

The electrical wire (12) protrudes from the rear end of the body (10) and has an end and a plug (121). The plug (121) is mounted on the end of the electrical wire (12) and has a contact (1211). The contact (1211) corresponds to the biosensor (20), thereby allowing the contact (1211) to be inserted into the insertion slot (16) of the ejection device in a biosensor detector (30) to contact the detecting circuit (100). Therefore, the electrical wire allows the sensor (30) be used away from the transducer, thereby allowing a patient to perform a blood test and a carer to monitor results of said test.

Furthermore, the carer can eject the biosensor (20) by pushing the ejection button (11) and without contacting the biosensor (20) so is convenient and safe for the carer.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A ejection device for a biosensor detector comprising:
a body having
a detecting circuit being mounted in an inner chamber;
an insertion slot being defined through one of ends of the body; and
an ejection mount being formed longitudinally in the upper surface of the body and having
a guide protrusion being mounted in the ejection mount; and
a first fastener being formed in the ejection mount;
an ejection button being mounted slidably in the ejection mount and having
an ejection tab being formed from one end of the ejection button, and having a bottom edge that is level with and adjacent to the insertion slot;
a second fastener protrudes from a lower surface of the ejection button and correspond and fasten respectively to the first fastener of the ejection mount to fasten the ejection button to the body; and
a limit being mounted in the recess and keeping a distance from the guide protrusion; and
a resilient element being mounted in the recess and having two ends and one of the ends being mounted on the guide protrusion and the other end being connected to the limit.

2. The ejection device for a biosensor detector as claimed in claim 1, wherein
the limit comprises
a protruding tab being formed on and protruding from the lower surface of the ejection button and being mounted in the recess; and
a sliding stopper being mounted between the protruding tab of the ejection button and the guide protrusion of the ejection mount, abutting the protruding tab;
one of the ends of the resilient element is mounted on the guide protrusion; and
the other end abuts the sliding stopper and presses the ends of the sliding stopper against the rear end of the recess.

3. The ejection device for a biosensor detector as claimed in claim 1, wherein
the ejection mount further has a partition forming an interval between the partition and the side of the recess;
the limit comprises has a protruding tab being a cylinder corresponding to and being mounted in the interval;
the resilient element is a helical torsion spring, wherein
one of the ends of the resilient element is mounted on the guide protrusion; and
the other end of the resilient element is mounted on the protruding tab.

4. The ejection device for a biosensor detector as claimed in claim 1, wherein
the first fastener comprises two button guides that are formed respectively in two sides of the ejection mount;
the second fastener comprises two guide tabs protruding from the lower surface of the ejection button, correspond respectively to and are slidably mounted respectively in the button guides of the first fastener to slidably hold the ejection button on the body.

5. The ejection device for a biosensor detector as claimed in claim 2, wherein
the first fastener comprises two button guides that are formed respectively in two sides of the ejection mount;
the second fastener comprises two guide tabs protruding from the lower surface of the ejection button, correspond respectively to and are slidably mounted respectively in the button guides of the first fastener to slidably hold the ejection button on the body.

6. The ejection device for a biosensor detector as claimed in claim 3, wherein
the first fastener comprises two button guides that are formed respectively in two sides of the ejection mount;
the second fastener comprises two guide tabs protruding from the lower surface of the ejection button, correspond respectively to and are slidably mounted respectively in the button guides of the first fastener to slidably hold the ejection button on the body.

7. The ejection device for a biosensor detector as claimed in claim 1, wherein the body further has a guiding platform being U-shaped and protruding from the end with the insertion slot of the body and corresponding to the insertion slot.

8. The ejection device for a biosensor detector as claimed in claim 2, wherein the body further has a guiding platform being U-shaped and protruding from the end with the insertion slot of the body and corresponding to the insertion slot.

9. The ejection device for a biosensor detector as claimed in claim 3, wherein the body further has a guiding platform being U-shaped and protruding from the end with the insertion slot of the body and corresponding to the insertion slot.

10. The ejection device for a biosensor detector as claimed in claim 1, wherein the body further has an electrical wire connecting to the biosensor detector.

11. The ejection device for a biosensor detector as claimed in claim 2, wherein the body further has an electrical wire connecting to the biosensor detector.

12. The ejection device for a biosensor detector as claimed in claim 3, wherein the body further has an electrical wire connecting to the biosensor detector.

13. The ejection device for a biosensor detector as claimed in claim 10, wherein the electrical wire has a plug being mounted on one end of the electrical wire to connect electrically to the biosensor detector.

14. The ejection device for a biosensor detector as claimed in claim 11, wherein the electrical wire has a plug being mounted on one end of the electrical wire to connect electrically to the biosensor detector.

15. The ejection device for a biosensor detector as claimed in claim 12, wherein the electrical wire has a plug being mounted on one end of the electrical wire to connect electrically to the biosensor detector.
